(19) United States
(12) Patent Application Publication
(10) Pub. No.: US 2007/0140919 A1
(43) Pub. Date: Jun. 21, 2007

(54) Sample vessel

(76) Inventors: John Michael Clarkson, Bradforf on Avon (GB); David Andrews, London (GB)

Correspondence Address: Mitchell, Silberberg & Knupp, LLP, 11377 West Olympic Boulevard, Los Angeles, CA, 90064, US

(21) Appl. No.: 10/539,306

(22) PCT Filed: Dec. 17, 2003
(86) PCT No.: PCT/GB03/05485

§ 371 Date: Sep. 25, 2006

(30) Foreign Application Priority Data
Dec. 17, 2002 (GB) 0229410.6

(51) Int. Cl. B01L 3/00

(52) U.S. Cl. 422/102

(57) ABSTRACT

The invention provides a method of making a sample vessel comprising: (a) melting a plastics material (b) introducing the molten plastics material into a mold, and (c) allowing the plastics material to set in the mold; wherein the mold defines a cavity with the shape of a sample vessel which comprises a tubular portion, which tubular portion has a maximum external cross sectional width of up to 5 mm and an internal sample volume of up to 100 μl wherein the tubular portion comprises a tubular external wall with a thickness of from 0.01 to 2 mm.

This invention relates to sample vessels for diagnostic, experimental and other laboratory procedures and methods associated therewith.

In many laboratory and diagnostic procedures a sample is held in a vessel whilst the laboratory or diagnostic procedure is carried out. In many such procedures it is advantageous for a sample vessel to have good thermal conductivity and/or a shape that aids heat transfer. Many laboratory or diagnostic procedures involve steps in which a sample is heated or cooled and those steps are most efficient if the material from which the vessel is made has good thermal conductivity and/or the vessel has a shape that aids heat transfer.

A large number of diagnostic procedures include steps in which temperature changes are effected in a sample. Tight control over the temperature of a sample is required in order to achieve reproducible and accurate results. That tight control of the temperature of a sample may be required, for example, to achieve optimal enzyme activity, to ensure effective denaturation of double stranded nucleic acids or to enable correct annealing of oligonucleotides, for example oligonucleotide primers.

One molecular application in which controlled heating is particularly important is the polymerase chain reaction (PCR). The principle of the PCR nucleic acid amplification technique is described in U.S. Pat. No. 4,683,195 (Cetus Corporation/Roche). Apparatus for carrying out the PCR reaction have been described in, for example, European Patent application EP 0 236 069 (Cetus Corporation/Roche/PE). Such apparatus are commonly referred to as “thermocyclers”.

Briefly, in a PCR reaction, a sample is subjected to a cycling between three phases:
1. Denaturation, during which a mixture of the target DNA, individual nucleotide bases (usually A, T, C and G), primers and a suitable DNA polymerase are heated to a relatively high temperature (typically over 80° C.) so that the two strands of the target DNA separate;
2. Annealing, during which the primers are allowed to anneal to the target DNA at a relatively low temperature (typically around 50° C. to 60° C.); and
3. Extension, during which the DNA polymerase synthesises strands of oligonucleotides complimentary to the target strands at an intermediate temperature (typically around 70° C.).

In theory the quantity of target DNA present is doubled in each cycle. The cycle is repeated as many times as necessary to obtain a desired quantity of product, typically around 30 times.

The efficiency of a PCR amplification procedure is heavily dependent on the rates at which the sample is cycled between the various temperatures and the accuracy of the temperature control and, accordingly, it is desirable for accurate, yet rapid, heating and cooling to be used. It is advantageous if the materials from which the vessel containing the sample is made and the shape of the vessel are such that rapid heat transfer to and from the sample is possible so as to minimize the time lag before the majority of a sample reaches a target temperature. That time lag is commonly the rate determining step in the procedure.

With some reaction vessel geometries and reaction vessel materials, the variation of temperature across a sample can also be relatively large, leading to further inaccuracies and thus reaction inefficiencies. Temperature variations of up to 10° C. are common in the case of plastic 0.2 ml or 0.5 ml tubes suitable for biological reactions, for example tubes of the type commonly known as Eppendorf tubes.

In many applications, the sample is interrogated in a spectrophotometric manner. In a typical spectrophotometry experiment, light (of a single or of a mixture of different wavelengths) is shone onto or through a sample and the amount of light transmitted, reflected or emitted from the sample (of the same or a different wavelength from the source light) is analysed. In order for such an experiment to be effective, it is necessary for the sample vessel to be transparent at the relevant wavelengths of light.

The requirement for good thermal conductivity and frequent desirability for transparency has made it usual for sample vessels for such experiments to be made of glass. Glass is a well characterized material with known manufacturing handling properties. Glass sample vessels are generally made by an extrusion or a molding process or by a molding of two or more separate parts followed by a fusing together of the parts to form the final vessel.

As is well known, however, glass has the major disadvantage that it is brittle and structurally weak. Breakage occurs easily during handling of glass vessels. When a glass vessel breaks there is a strong tendency for the site of the breakage to be left with sharp edges, which constitute a hazard for laboratory staff or other workers. Breakage of glass vessels may also result in the contamination of the device in which the vessel is being used, the surrounding area and other samples. There is therefore a demand for vessels with many of the advantageous properties of glass but without its structural fragility and propensity to generate hazards.

Large items of laboratory equipment, for example conical flasks or measuring cylinders, have been available in plastics materials for some time, as have some smaller, low precision items, such as Eppendorf tubes. Small, precision items of laboratory equipment place greater demands on the materials of construction as described above with reference to optical transmission and heat transfer. In many cases it is, in addition, necessary to form intricate vessel parts accurately and reproducibly. There remains a need for improved methods of making sample holding vessels for diagnostics applications from polymeric materials in a reliable fashion.

The invention accordingly provides a method of making a sample vessel comprising:

a) melting a plastics material

b) introducing the molten plastics material into a mold, and

c) allowing the plastics material to set in the mold

wherein the mold defines a cavity with the shape of a sample vessel which comprises a tubular portion, which tubular portion has a maximum external cross sectional width of up to 5 mm and an internal sample volume of up to 100 μl wherein the tubular portion comprises a tubular external wall with a thickness of from 0.01 to 2 mm.

The method of the invention provides a straightforward route to a convenient, easy to handle, versatile sample vessel. A sample vessel made according to a method of the invention has many of the beneficial properties of glass but without the fragility of a glass tube. In addition, it is generally cheaper to manufacture a plastic vessel than a glass vessel of the same shape.

The tubular portion of the sample vessel comprises a tubular external wall. Preferably, the wall has a thickness in the range of from 0.03 mm to 1 mm, more preferably in the range of from 0.1 to 0.5 mm, for example approximately 0.3 mm. The thickness of the external wall of the vessel at any given location along the vessel's length is less than half of the external diameter of the vessel at that location. The thickness of the wall has a large influence on the efficiency of heat transfer into and out of the vessel.

The tubular portion of the sample vessel is the portion of the vessel intended for holding the sample. Typically, the tubular portion has a length of from 3 to 50 mm, preferably from 5 to 30 mm, more preferably 10 to 25 mm. The tubular portion preferably has an internal sample volume of from 2 to 50 μl, more preferably from 10 to 35 μl, for example from 20 to 30 μl. It is generally preferable for the sample vessel to comprise a portion above the tubular portion to accommodate a closure means or to reduce the risk of spillage. The total internal volume of the whole sample vessel may therefore be greater than the internal volume of the tubular portion.

Preferably the sample vessel according to the invention enables a sample within it to be heated rapidly, preferably, a sample within a sample vessel of the invention can be heated at a rate of 1 degree C. or more per second, more preferably, 2 degrees C. or more per second, still more preferably 3 degrees C. or more per second. Typically, the sample vessel of the invention is used at temperatures in the range of 40 to 100 degrees C. The heat source must not be so hot as to melt the tube.

A sample vessel made according to the method of the invention preferably has a truncated conical external surface, the angle between a meridian of the truncated conical external surface and the axis of the cone being in the range of from 0.1 degrees to 10 degrees and the truncated cone being closed at its narrower end and open at its wider end. That “tapering” of the external surface enables the finished molded vessel to be easily removed from the mold. Preferably the angle between a meridian of the truncated conical external surface and the axis of the cone is in the range of from 0.2 degrees to 8 degrees, more preferably in the range of from 0.5 degrees to 5 degrees, for example in the range of from 1 degree to 3 degrees.

Preferably, a sample vessel made according to the method of the invention has a tubular portion with a maximum external cross sectional width of less than 4 mm, more preferably less than 3 mm. Generally, a sample vessel made according to the method of the invention has a tubular portion with a maximum external cross sectional width in the range of from 0.2 to 5 ml, preferably in the range of from 0.5 to 4 mm, for example in the range of from 1.0 to 3.0 mm.

In a preferred embodiment of the invention, the sample vessel is a sample tube, more preferably, a sample tube for diagnostic analysis of a sample.

Preferably, the internal surface of the tubular external wall of a vessel made according to a method of the invention is also tapered, that is to say that the angle between a meridian of the truncated conical internal wall surface and the axis of the cone is in the range of from 0.1 degrees to 10 degrees, more preferably in the range of from 0.5 degrees to 5 degrees, for example in the range of from 1 degree to 3 degrees. In such a vessel, the wall accordingly does not define a perfectly cylindrical cavity.

Preferably, the mean internal cross sectional width of the cavity of the tubular portion (that is to say twice the average perpendicular distance of the wall from the axis of the cylinder averaged along the length of the axis) is in the range of from 0.02 mm to 4.9 mm, more preferably in the range of from 0.1 to 4.0 mm, more preferably in the range of from 0.5 to 3.0 mm, for example in the range of from 1.0 to 2.0 mm, for example 1.5 mm. The internal measurements of the cavity are dictated by the chosen external measurements and the chosen external wall thickness. Preferably, the cross sectional width of the cavity is such that a standard gel loading sequencing pipette tip can be inserted all or substantially all the way to the bottom of the cavity.

Preferably the plastics material for use in the method of the invention is a cyclo-olefin copolymer, a cyclo-olefin polymer or polypropylene. Preferably the plastics material for use in the method of the invention is a cyclo-olefin copolymer or a cyclo-olefin polymer. Preferably the plastics material has a glass transition temperature of over 100° C.

The method of the invention allows the creation of a vessel with a thinner wall than has conventionally been possible by polymer molding. Molding narrow plastic parts is generally problematic as the plastic melt does not flow easily into narrow cavities. Preferably the plastics material has a melt flow index of 20 or above, more preferably 25 or above, most preferably 35 or above, for example 45 or above. The method of the invention has particular applicability in the production of thin walled vessels.

Advantageously the plastics material for use in the method of the invention is a cyclo-olefin copolymer (“COC”). It has surprisingly been found that vessels molded from cyclo-olefin copolymers have particularly advantageous properties with regard to structural integrity and strength, heat conduction and optical transparency. COCs are known for example from EP 0 407 870.

A particularly preferred COC is a copolymer of ethylene and norbornene. Such a copolymer is available at the time of filing from Ticona GmbH (Lyoner Strasse 38, D-60528 Frankfurt am Main, Germany) under the tradename Topas®. The synthesis of COCs has been described for example in EP 0 407 870 or EP 0 610 813. COCs with glass transition temperatures of over 100° C. may be produced by co-polymerisation of acyclic olefin monomer and a cyclic olefin monomer in the presence of particular catalysts. For example a metallocene catalyst may be used as described in EP 0 407 870. Topas COCs consist of amorphous, transparent copolymers based on cyclo olefins and linear olefins. Various grades of COCs are available from Ticona GmbH, for example Topas 8007, Topas 6013, Topas 6015. Topas 5013 and Topas 6017. Preferably, Topas 5013 is used in the method of the invention. Selected physical properties of Topas 5013 are given in table 1.

TABLE 1

| Property | Unit | Test Method | Topas 5013 |
|---|---|---|---|
| Volume flow index MVR at | ml/10 min | ISO 1133 | 56 |
| 260° C./2.16 kg | | | |
| Volume flow index MVR at | ml/10 min | ISO 1133 | 25 |
| HDT + 115° C./2.16 kg | | | |
| Density | g/cm³ | ISO 1183 | 1.02 |
| Water absorption (24 h | % | ISO 82 | <0.01 |
| immersion in water at | | | |
| 23° C.) | | | |
| Water vapour permeability | g · mm | DIN 53 122 | 0.030 |
| at 23° C. and 85% | m² · d | | |
| relative humidity | | | |
| Mold shrinkage (ν_{w} = | % | — | 0.4-0.7 |
| 60° C., 2 mm wall | | | |
| thickness) | | | |

Mechanical properties, measured under standard conditions,
ISO 291-23/50

| | | | |
|---|---|---|---|
| Tensile strength | MPa | ISO 527 | 66 |
| | | parts 1&2 | |
| Elongation at break | % | testing rate | 3 |
| Tensile modulus | MPa | 50 mm/min. | 3100 |
| Impact strength (Charpy) | KJ/m² | ISO 179/1eU | 13 |
| Notched impact strength | KJ/m² | ISO 179/1eA | 1.7 |
| (Charpy) | | | |
| Ball indentation hardness, | N/mm² | ISO 2039 | 184 |
| 30-sec value | | part 1, | |
| | | applied load | |

Thermal Properties

| | | | |
|---|---|---|---|
| Heat deflection temperature | ° C. | ISO 75 | 130 |
| HDT/B (0.45 MPa) | | parts 1&2 | |
| Coefficient of linear | ° C.⁻¹ | ISO 11359 | 0.6 10⁻⁴ |
| thermal expansion | | parts 1&2 | |

Electrical Properties

| | | | |
|---|---|---|---|
| Relative permitivity εᵣ, | — | IEC 60250 | 2.35 |
| at 1-10 kHz | | | |
| Comparative tracking | — | IEC 60112 | >600 |
| index CTI | | | |
| Volume resistivity | Ohm · m | IEC 60093 | >10¹⁴ |

Flammability

| | | | |
|---|---|---|---|
| UL Flammability Rating | class | UI 94 | HB (1.6 mm) |
| | analogous | | |

Optical Properties

| | | | |
|---|---|---|---|
| Light transmission | % | ASTM D 1003 | 93 |
| (2 mm wall thickness) | | | |
| Refractive index | — | — | 1.53 |
| Abbe number | — | — | 58 |

Preferably, molten cyclo-olefin copolymer (COC) is introduced into the mold by injection. Injection of COC into narrow cavity sections (such as the cavity sections defining the vessel walls) is possible because of its high melt flow rate. Preferably, the COC is injected at a temperature of from 240 to 300 degrees C., more preferably at approximately 270 degrees C. Preferably, the COC is injected at a temperature 110 to 170 degrees above its glass transition temperature.

As mentioned above, an alternative advantageous plastics material for use in the method of the invention is a cyclo-olefin polymer, preferably an amorphous cyclo-olefin polymer thermoplastic resin. A particularly preferred amorphous cyclo-olefin polymer thermoplastic resin is one based on dicyclopentadiene. Such a cyclo-olefin polymer thermoplastic resin is available at the time of filing from Zeon Chemicals (Zeon Europe GmbH, Düsseldorf, Germany) under the tradename Zeonex® or Zeonor®.

Preferably, the plastics material is selected such that optical transmission through the vessel to the sample is high. Such a material enables a sample in the vessel to be spectrophotometrically analysed whilst in the vessel. For example, the material is preferably not opaque.

In addition to the tubular portion, the sample vessel shape which is defined by the mold in the method of the invention may comprise a neck portion at the open end of the tubular portion. The neck portion may comprise a section of frustoconical shape directly or indirectly adjoining the tubular portion, which section increases in external and optionally also internal cross sectional width in the direction away from the tubular portion. The section of frustoconical shape may be connected directly to the tubular portion, or it may be connected to the tubular portion through an intermediate portion, the intermediate portion also forming a part of the neck portion. The intermediate portion may have a wider external wall than the tubular portion. The intermediate portion may have an external wall that has the same width as the external wall of the section of frustoconical shape.

The neck portion may alternatively or additionally comprise a cylindrical portion for receiving a closure means. The closure means may be a stopper. In a preferred embodiment, the closure means seals in an airtight manner and insertion of the closure means into the cylindrical portion causes compression of air in the vessel. The cylindrical portion is preferably sufficiently long to receive and hold in place the closure means. The cylindrical portion may have any suitable cross sectional shape, for example it may be rectangular, ovoid or circular.

The closure means may be held in place primarily by friction between the closure means and the internal surface of the cylindrical portion. If the closure means is held in place primarily by friction, a degree of structural strength of the cylindrical portion of the vessel is required to maintain the seal. The closure means may, alternatively be held in place by a clip or other mechanical securing device.

With a closure means in place, the ambient air pressure in the vessel is generally greater than atmospheric pressure by virtue of the seal formed when the closure means engages with the cylindrical portion and the subsequent insertion of the closure means. That over-pressurisation raises the boiling point of the sample liquid and reduces the risk of degassing of the sample.

Degassing of a sample solution (also known as “bumping”) may, if not controlled, lead to sudden, violent eruptions of bubbles from the body of the sample solution which may result in spillage if the sample vessel is not securely sealed. Even if the sample vessel is securely sealed, degassing may result in redistribution of sample fluid to non-ideal parts of the sample vessel. For example, a part of the sample may be moved to a portion of the sample vessel at which heating and/or cooling is not as efficient as at the portion of the vessel in which the sample is intended to be located. Bubbles may also hinder spectrophotometric measurements of the sample. The risk of bubbles causing those problems is much reduced by the application of air pressure greater than atmospheric pressure. Suitably, pressure of from 1.5 to 3.0 atmospheres is built up by application of the closure means, more preferably approximately 2 atmospheres.

The degree of over-pressurisation that is required has an impact on the design of the sample vessel as a whole. The pressure that is achieved with the closure means in place is determined by the ratio of the volume available for air in the sample vessel without the closure means in place and the volume available for air in the sample vessel with the closure means in place. Thus, use of the same vessel with samples of different volumes results in different volumes of air being in the sample vessel above the sample and thus in a different over-pressurisation being achieved upon application of the closure means. Accordingly, if a vessel is intended for use with, for example, a particularly small sample volume, the vessel should have a total volume that allows for a head-space air volume appropriate to the required over-pressurisation.

The closure means is preferably made of a resilient plastics material. It is preferably sufficiently pliable for it to adapt to the shape of the cylindrical portion of the sample vessel and form a tight seal, but sufficiently rigid to remain strongly in place. The closure means may be made of a thermoplastic elastomer rubber, as available for example from Advanced Elastomer Systems (Advanced Elastomer Systmes NV.SA, Unit 1 Harcourt Way, Meridian Business Park, Barunstone, Leicester LE3 2WP, UK) under the tradename Santoprene®. Other plastics materials are also suitable for use in the closure means of the invention, for example polypropylene or polycarbonate.

As mentioned above, it is common for samples to be analysed spectrophotometrically in a sample vessel. Conveniently, in the case of a sample vessel, optical communication between the spectrophotometric device and the sample occurs through the tip of the vessel. Typically, the view through the end of the vessel affords the longest optical path length through the sample. Optical communication through the tip of a sample vessel may be achieved efficiently if the tip of the sample vessel additionally acts as a lens. The lens action of the tip may be achieved by the tip being convexly curved. For example, the sample vessel tip may have the shape of a segment of a sphere. The external surface of the tip is preferably smooth such that scattering of light due to stray diffraction is minimized. The tip accordingly has a higher light transmissivity than the remainder of the vessel. A smooth external surface of the sample vessel may be furnished by the presence in the mold for the sample vessel of a highly polished mold portion at the tip of the mold.

The sample vessel defined by the mold in the method of the invention accordingly advantageously comprises portions of different external diameters, for example a neck portion and a tubular portion. Preferably the external diameter of the vessel decreases from the open end of the vessel to the closed end of the vessel in a series of steps, preferably at least two steps.

Likewise, the sample vessel advantageously comprises portions of different internal diameters, for example a neck portion and a tubular portion. Preferably the internal diameter of the vessel decreases from the open end of the vessel to the closed end of the vessel in a series of steps, preferably at least two steps.

The consequent series of steps in the internal and/or external diameters leads to the thickness of the vessel wall to decrease in a step-wise manner from the open end of the vessel to the closed end of the vessel. That series of steps enables the plastics material to flow more readily to the thin, closed end of the vessel mold than would otherwise be possible.

The invention further provides a molded plastics sample vessel which sample vessel comprises a tubular portion with a maximum external cross sectional width of up to 5 mm and an internal sample volume of up to 100 μl wherein the tubular portion comprises a tubular external wall with a thickness of from 0.01 to 2 mm.

Advantageously, the molded sample vessel of the invention is made using a method of the invention. A molded sample vessel of the invention may have any of the features described above in relation to the method of the invention.

A sample vessel according to the invention finds application, for example, in thermal cycling devices. Various devices have been developed for simultaneous thermal cycling of a plurality of samples. One example of such a device is the LightCycler®, available from Roche Diagnostics (Roche Diagnostics Ltd., Bell Lane, Lewes, East Sussex, BN7 1LG, U.K.). A device with many of the features of the Lightcycler device is described in WO 97/46707 and WO 97/46712. In the Lightcycler device, a carousel having a plurality of sample tube receiving slots is located in a enclosed housing. The housing is in communication with a fan and a heater. In use, sample tubes containing the samples of interest are inserted into the carousel. During a heating phase, the fan blows hot air into the housing, causing the samples to be heated. During a cooling phase, the housing is vented and the fan blows cold air into the apparatus. An optical detection unit comprising a light source and a fluorescence detector is arranged to interrogate the contents of one vessel at a time along the length of the tube. The carousel rotates such that each sample tube may be aligned with the optical detection unit in turn.

Fluorescence-based approaches to real-time measurement of PCR amplification products have been proposed and are in common usage. Some such approaches have employed double-stranded DNA binding dyes (for example major or minor groove-binding intercalating dyes, for example SYBR Green I® system or ethidium bromide) to indicate the amount of double stranded DNA present. Other approaches have employed probes containing fluorescer-quencher pairs (for example the “TaqMan” ® or “HYB-Probes” approach) that are cleaved during amplification to release a fluorescent product the concentration of which is indicative of the amount of double stranded DNA present. Such fluorescer-quencher pair methods typically make use of fluorescence resonance energy transfer (FRET). Adaptations of those approaches are known (as described in, for example, WO 95/30139), in which two or more dyes are used.

A sample tube according to the invention is particularly suitable for use with the above-mentioned fluorescence systems. Commonly used emission wavelengths include 530 nm (fluorescein), 640 nm (LC Red 640) and 710 nm (LC Red 705).

It is also common to detect the presence of a particular amplification product by means of hybridisation probes. Such probes may be provided with fluorescent dyes with a variety of emission characteristics and, in a given experiment, it may be desirable to use more than one dye. The apparatus of the invention is also suitable for use in such detection systems. The ability to analyse a plurality of wavelengths of light without the need for moving parts is particularly advantageous for such applications.

Advantageously, a plurality of sample vessels of the invention may be supplied in a sample vessel holder unit. The sample vessel holder may be configured in such a way that the plurality of vessels are positioned in an array. The plurality of vessels may be arranged in such a way that they may be presented to a heater/cooler device or an optical analysis device in alignment with heater/cooler elements or optical analysis elements of the device. If an optical analysis element is present, it is generally important for the sample vessels to be positioned accurately relative to the optical analysis unit. Accordingly, it is important for the sample vessel holder unit to be accurately manufactured and to be sufficiently mechanically stable to hold the sample vessels in place accurately during use. A sample vessel holder unit is preferably made of a suitable plastics material, for example a polycarbonate or a styrenic resin, for example ABS (a copolymer of acrylonitrile, butadiene and styrene) may be used.

A sample vessel holder unit may comprise any suitable number of sample vessels of the invention. Preferably a sample vessel holder unit comprises from 2 to 384 sample vessels of the invention, more preferably, from 4 to 96 sample vessels of the invention, for example 12 sample vessels of the invention. Sample vessels of the invention may be attached to the sample holder unit in a permanent manner or they may be detachable from the sample holder unit.

For use with a sample vessel holder unit comprising a plurality of sample vessels, a closure means unit may be provided which comprises a plurality of closure means. Such a closure means unit preferably comprises a planar body with a plurality of closure means attached at a roughly perpendicular direction. The closure means unit may be made of a resilient plastics material. Preferably it is a molded plastics material.

A sample holder unit may be provided with a stand such that the unit can be positioned steadily for sample loading without it being necessary for the operator to touch the sample vessels. The stand is preferably made of a transparent material or comprises voids such that sample vessels in the holder are visible to the operator whilst a sample is being deposited in a sample vessel. Contact of the operator with the sample vessels risks contamination of the sample or the leaving of fingerprints on the sample receiving vessel which may interfere with optical assessment of the sample. Use of a sample holder stand further reduces the risk of breakages occurring. Breakage of vessels may result in the contamination of the device in which the vessel is to be used, the surrounding area and other samples.

The invention also provides a method of making a sample vessel comprising:

a) melting a plastics material

b) introducing the molten plastics material into a mold, and

c) allowing the plastics material to set in the mold

wherein the mold defines a cavity with the shape of a sample vessel which comprises a tubular portion, which tubular portion has a maximum external cross sectional width of up to 5 mm wherein the tubular portion comprises a tubular external wall with a thickness of from 0.01 to 2 mm.

Various embodiments of the invention will now be described in more detail with reference to the accompanying figures, in which

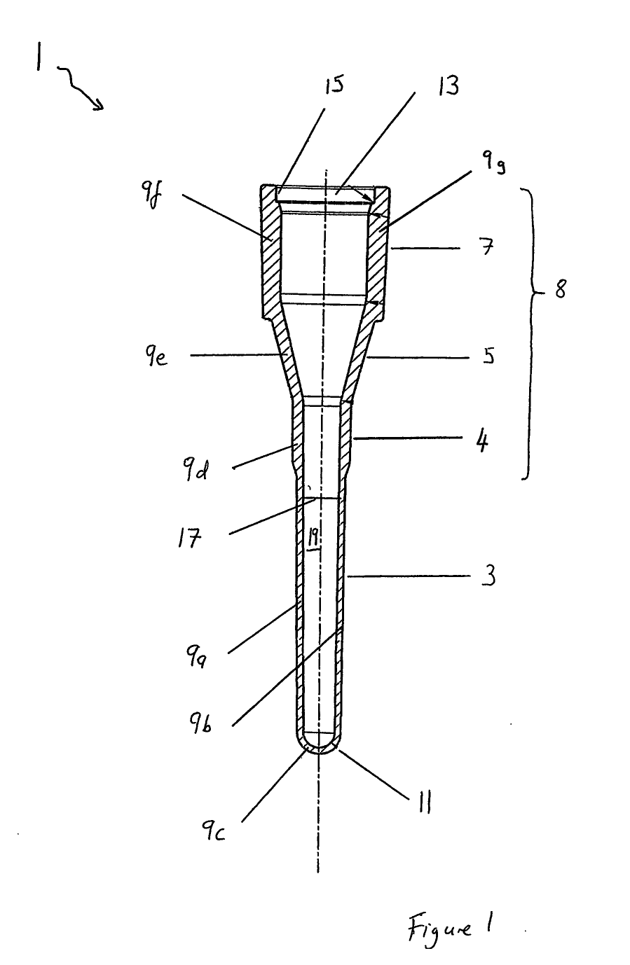

FIG. 1 shows a sample tube of the invention;

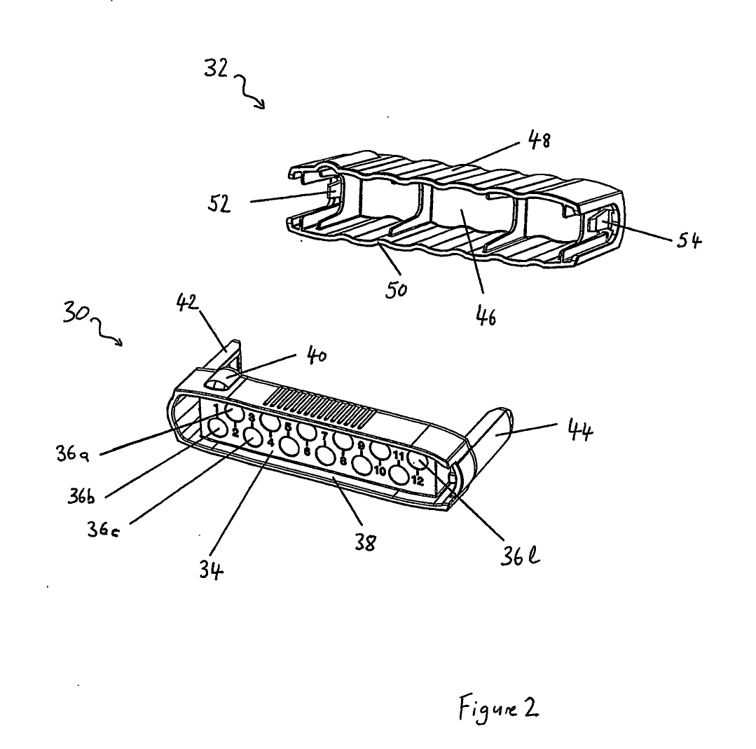

FIG. 2 shows a sample holder and sample holder stand suitable for use in a device of the invention;

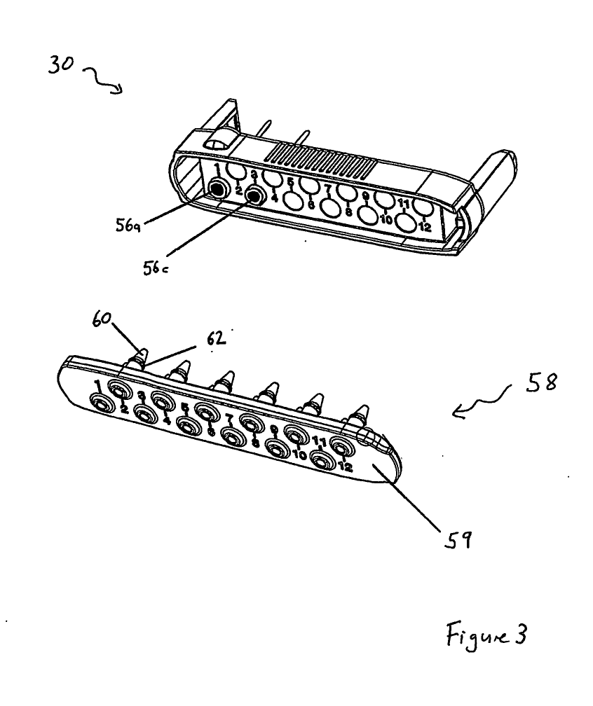

FIG. 3 shows a sample holder unit with sample tubes in place together with a closure means unit; and,

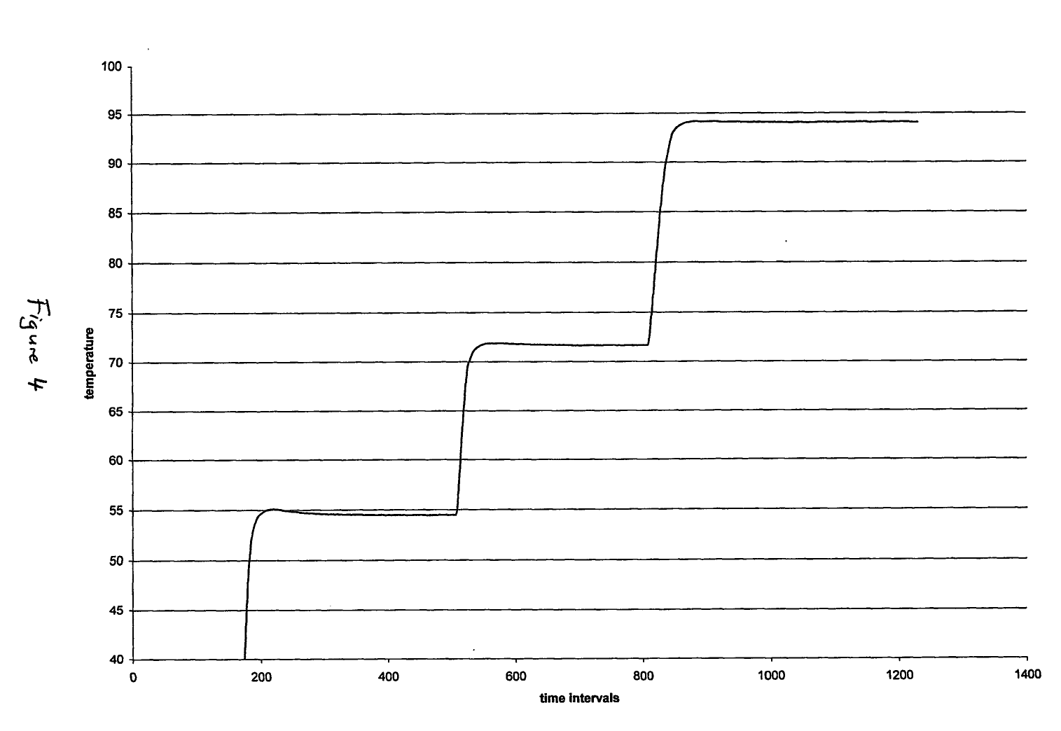

FIG. 4 shows the temperature changes achieved in a sample in use.

In FIG. 1 there is shown a sample tube indicated generally as reference numeral 1. Sample tube 1 comprises a tubular portion 3, an intermediate portion 4, a frustoconical portion 5 and a cylindrical portion 7. Frustoconical portion 5, intermediate portion 4 and cylindrical portion 7 together form a neck portion 8. Sample tube 1 comprises a closed tip 11 and an open end 13.

Tubular portion 3 comprises a wall 9a, 9b of truncated conical internal and external shape. The internal and external faces of each of walls 9a and 9b are parallel to each other in cross section in a plane including the axis of the tube, that is to say the each of walls 9a and 9b is of constant thickness along the length of tubular portion 3. The diameter of the tubular portion becomes smaller towards tip 11. At tip 11, the wall 9c has the shape of a segment of a hollow sphere. In the embodiment shown, walls 9a and 9b have a thickness of 0.3 mm, the external diameter of tubular portion 3 is 1.2 mm at its wider, open, end and 1.1 mm at it narrower, closed end.

Tubular portion 3 is connected, at its open end, via intermediate portion 4 to frustoconical portion 5. Closest to tubular portion 3, intermediate portion 4 has a widened external wall 9d and the internal shape of the tube is a continuation of the line of internal face of wall 9a/9b. Further towards opening 13 is frustoconical portion 5 in which the wall of the tube has a more pronounced conical shape (9e) and the diameter of the internal and the external surfaces of the sample tube wall increase towards the neck of the tube.

Frustoconical portion 5 is connected at its wider end to cylindrical portion 7. In cylindrical portion 7, the walls 9f and 9g are wider than in frustoconical portion 5 and the internal faces of walls 9f and 9g are, when seen in cross section from the side of the tube, parallel. At the opening 13, the cylindrical portion 7 is provided with an indentation 15 around the rim.

In use sample tube 1 is filled with sample fluid 19 up to level 17 by means of a pipette furnished with a gel loading sequencing tip. A closure stopper 21 (not shown) is then introduced into cylindrical portion. Closure stopper 21 is designed to fit into cylindrical portion 7 in an airtight manner and the stopper is so arranged that full insertion of the closure stopper can increase the air pressure above sample fluid 19.

Sample tube 1 finds application, for example, in PCR amplification methods, for example in a thermal cycler device. Upon insertion of sample tube 1 into a thermal cycler, the tubular portion 3 containing sample fluid 19 is heated and cooled. Heat transfer to and from sample fluid 19 is rapid on account of the thin wall 9a/9b at that portion of the tube. Relatively little heat is transferred to or from the surroundings into the tube cavity in the frustoconical portion 5 or the neck portion 7 because the thicker tube walls 9d, 9e and 9f do not conduct heat as efficiently as the thinner walls 9a and 9b in the tubular portion.

Referring to FIG. 2, there is shown a sample tube holder referred to generally as 30 and a sample holder stand referred to generally as 32. Sample tube holder 30 comprises a roughly rectangular plate 34 furnished with 12 sample vessel receiving holes 36a to 361 defined by circular apertures. Sample vessel receiving holes 36a to 361 are arranged in two lines of 6 holes each. Plate 34 is surrounded by an external wall 38 which protrudes above the level of plate 34. On one side of sample tube holder 30 there is located a protrusion 40 which serves to desymmetrise the sample tube holder. At each of the two ends of plate 34, and perpendicular to the plate there is attached an arm 42 and 44.

Sample holder stand 32 comprises a roughly rectangular base 46 and front and rear walls 48 and 50 which project perpendicularly from the base. At the ends of the two walls, the gap between the walls is shaped to receive arms 42 and 44 of sample tube holder 30. Protruding into the arm receiving space at each end of the sample holder stand is a clip 52 and 54 respectively for engaging with a notch in the respective arm.

In use sample tube holder 30 is initially engaged with sample tube holder stand 32. A sample tube 56 (not shown in FIG. 2) is located in each of as many of the sample receiving holes as required. Sample tube 56 is protected from breakage or contact with the operator by the walls 48 and 52. After sample has been loaded into as many of the sample tubes as required, a sample tube sealing closure means 58 (shown in FIG. 3) is pressed into the sample tubes to seal them, sample tube holder 30 is disengaged from sample tube holder stand 32 and moved to the designated slot in an analytical device (not shown).

In FIG. 3 there is shown a sample tube holder 30 with two sample tubes 56a and 56c in place together with multiple sample tube sealing closure unit 58. Multiple sample tube sealing closure means 58 comprises an essentially planar backing member 59 and a protruding stopper member 60 for each sample tube. The lid 58 is made of a resilient material such that circular lip 62 on each stopper member 60 forms a tight seal when inserted into its respective sample tube. In use, insertion of a stopper member 60 into a sample tube causes the air in the tube to be compressed.

### EXAMPLE

A sample vessel of the type shown in FIG. 1 and described above was loaded with 30 μl of mineral oil sample and heated in a hot air stream heater whilst being held in a sample tube holder of the type shown in FIGS. 2 and 3. The temperature of the sample was monitored using a PT100 platinum resistance temperature sensor positioned within the sample tube 5 mm from the distal end of the tube. The sample was first heated to 55 degrees C., then to 72 degrees C. and lastly to 94 degrees C. The observed data are shown in FIG. 4. Four temperature measurements were taken each second in the experiment. Accordingly each of the x-axis “time intervals” corresponds to 0.25 sec. The temperature transitions at each stage take place over from 5 to 8 seconds and the measured gradient of the curve during the transition was 3.48 degrees C./s for the transition from 55 to 72 degrees C. and 2.81 degrees C./s for the transition from 72 to 94 degrees C.

1. A method of making a sample vessel comprising:
a) melting a plastics material;
b) introducing the molten plastics material into a mold; and
c) allowing the plastics material to set in the mold
wherein the mold defines a cavity with the shape of a sample vessel which comprises a tubular portion, which tubular portion has a maximum external cross sectional width of 5 millimeters (mm) and an internal sample volume of not more than 100 microliters (μl), wherein the tubular portion comprises a tubular external wall with a thickness of from 0.01 to 2 mm.

2. A method as claimed in claim 1 wherein the tubular external wall has a thickness in the range of from 0.1 mm to 0.5 mm.

3. A method as claimed in claim 1 in which the molten plastics material is introduced into the mold by injection.

4. A method as claimed in claim 1 in which the tubular portion
has a truncated conical external surface, the angle between a meridian of the truncated conical external surface and the axis of the cone being in the range of from 0.1 degrees to 10 degrees,
is closed at its narrower end, and
is open at its wider end.

5. A method as claimed in claim 1 in which the tubular portion has an external cross sectional width of less than 3 mm.

6. A method as claimed in claim 1 in which the mean internal cross sectional width of the cavity of the tubular portion is in the range of from 0.02 mm to 4.9 mm.

7. A method as claimed in claim 1 in which the sample tube further comprises a section of frustoconical shape directly or indirectly adjoining the tubular portion, which section increases in external diameter in the direction away from the tubular portion.

8. A method as claimed in claim 1 in which the sample tube further comprises a neck portion comprising a cylindrical portion for receiving a closure means.

9. A method as claimed in claim 1 in which the mold comprises a highly polished portion at the tip of the mold.

10. A method as claimed in claim 1 in which the plastics material is a cyclo-olefin copolymer, a cyclo-olefin polymer or polypropylene.

11. A method as claimed in claim 1 in which the plastics material is a cyclo-olefin copolymer.

12. A method as claimed in claim 1 in which the plastics material is an amorphous cyclo-olefin polymer.

13. A method as claimed in claim 1 in which the plastics material is polypropylene.

14. A molded plastics material sample vessel comprising a tubular portion which has a maximum external cross sectional width of 5 millimeters (mm) and an internal sample volume of not more than 100 microliters (μl) wherein the tubular portion comprises a tubular external wall with a thickness of from 0.01 to 2 mm.

15-21. (canceled)

22. A method as claimed in claim 1 in which the plastics material is a cyclo-olefin copolymer of ethylene and norbornene.

23. A molded plastics material sample vessel according to claim 14, wherein the tubular portion:
has a truncated conical external surface, the angle between a meridian of the truncated conical external surface and the axis of the cone being in the range of from 0.1 degrees to 10 degrees,
is closed at its narrower end, and
is open at its wider end.

24. A molded plastics material sample vessel according to claim 14, further comprising a section of frustoconical shape directly or indirectly adjoining the tubular portion, which section increases in external diameter in the direction away from the tubular portion.

25. A molded plastics material sample vessel as claimed in claim 14 further comprising a neck portion that includes a cylindrical portion for receiving a closure means.

26. A method of using a sample vessel, comprising:
a) obtaining a sample vessel as recited in claim 14;
b) placing a sample into the sample vessel; and
c) at least one of heating the sample, spectrophotometrically analyzing the sample or subjecting the sample to a nucleic acid amplification reaction, while the sample is in the sample vessel.

27. A method according to claim 26, wherein the sample is spectrophotometrically analyzed during the nucleic acid amplification reaction.

28. A molded plastics material sample vessel which comprises a tubular portion having a maximum external cross sectional width of 3 millimeters (mm) and an internal sample volume of not more than 100 microliters (μl), wherein the tubular portion comprises a tubular external wall with a thickness in the range of from 0.1 mm to 0.5 mm, and wherein the tubular portion:
a) has a truncated conical external surface, the angle between a meridian of the truncated conical external surface and the axis of the cone being in the range of from 0.1 degrees to 10 degrees,
b) is closed at its narrower end, and
c) is open at its wider end, and
wherein the mean internal cross sectional width of the cavity of the tubular portion is in the range of from 0.5 mm to 3 mm, wherein the sample tube further comprises a section of frustoconical shape directly or indirectly adjoining the tubular portion, which section increases in external and internal diameter in the direction away from the tubular portion, and wherein the sample vessel is made of a cyclo-olefin copolymer of ethylene and norbornene.
